(19) United States
(12) Patent Application Publication
(10) Pub. No.: US 2023/0243926 A1
(43) Pub. Date: Aug. 3, 2023

(54) RANGING ERROR CALCULATION DEVICE, RANGING ERROR CALCULATION METHOD AND STORAGE MEDIUM

(71) Applicant: NEC Corporation, Minato-ku, Tokyo (JP)

(72) Inventor: Hisaya Wakayama, Tokyo (JP)

(73) Assignee: NEC Corporation, Minato-ku, Tokyo (JP)

(21) Appl. No.: 18/013,045

(22) PCT Filed: Jul. 30, 2020
(86) PCT No.: PCT/JP2020/026267

§ 371 Date: Dec. 27, 2022

(51) Int. Cl. G01S 7/48; H04N 17/00

(52) U.S. Cl. CPC G01S 7/4808; H04N 17/002

(57) ABSTRACT

A ranging error calculation device 1 includes a ranging information acquisition means 11, and a ranging error distribution information generation means 12. The ranging information acquisition means 11 is configured to acquire ranging information in time series with respect to a ranging target point for each of one or more feature information of the ranging target point. The ranging error distribution information generation means 12 is configured, based on the ranging information, to generate ranging error distribution information, for the each of one or more feature information, regarding an error distribution in measured distance from a ranging device to the ranging target point.

### TECHNICAL FIELD

The present disclosure relates to a ranging error calculation device, a ranging error calculation method, and a storage medium.

### BACKGROUND ART

In order to flexibly operate an AGV (Automated Guided Vehicle) and a robot in accordance with the change in the environment, it is necessary to properly recognize the outside environment using one or more sensing devices such as a LiDAR (Light Detection and Ranging), a laser, and a three-dimensional camera. On the other hand, the environmental information measured by these sensing devices includes the observation error. There are known some techniques to suitably remove the observation error and estimate the true value.

For example, Patent Literature 1 discloses a position posture measurement device configured to acquire a rough position of a target object based on a distance image and to adjust the sampling so as to decrease the number of sampling points with decreasing variation in the distance information in order to prevent a decrease in the accuracy of calculating the position posture of the target object based on the distance image while maintaining the processing speed.

### CITATION LIST

### Patent Literature

Patent Literature 1: JP 2011-179910A

### SUMMARY

### Problem to be Solved

There is a growing demand for testing the implementation of an AGV or a robot by simulation. It can suitably increase the introduction efficiency and operation efficiency of the AGV or the robot to perform the operation verification by simulation in advance and grasp the influence on the operation of the AGV or the robot from the layout of the building or the equipment and reflect them in the installation plan thereof.

However, the real environment is not perfectly reflected in the simulation. Especially, information relating to sensing is obtained through complicated physical phenomena such as propagation, diffractive, and transmission of light and radio waves in the real world, and therefore the information acquired includes the observation error. In most computer simulations today, these physical phenomena are not perfectly reproduced from the viewpoints of computational resources and required input information, and instead only simple physical phenomena such as gravity, friction, and reflection are reflected. As a result, almost all observation errors relating to sensing are eliminated in the simulation, and therefore the actual environment cannot be well reflected in the simulation. Therefore, it becomes insufficient to grasp issues by the simulation. Patent Literature 1 does not disclose such issues as described above and solutions thereof.

In view of the above-described issue, it is therefore an example object of the present disclosure to provide a range error calculation device, a ranging error calculation method, and a storage medium capable of suitably calculating information on the ranging error.

### Means for Solving the Problem

In one mode of the ranging error calculation device, there is provided a ranging error calculation including: a ranging information acquisition means configured to acquire ranging information in time series with respect to a ranging target point for each of one or more feature information of the ranging target point; and a ranging error distribution information generation means configured, based on the ranging information, to generate ranging error distribution information, for the each of one or more feature information, regarding an error distribution in measured distance from a ranging device to the ranging target point.

In one mode of the ranging error calculation method, there is provided a ranging error calculation method executed by a computer, the ranging error calculation method including: acquiring ranging information in time series with respect to a ranging target point for each of one or more feature information of the ranging target point; and based on the ranging information, generating ranging error distribution information, for the each of one or more feature information, regarding an error distribution in measured distance from a ranging device to the ranging target point.

In one mode of the storage medium, there is provided a storage medium storing a program executed by a computer, the program causing the computer to: acquire ranging information in time series with respect to a ranging target point for each of one or more feature information of the ranging target point; and based on the ranging information, generate ranging error distribution information, for the each of one or more feature information, regarding an error distribution in measured distance from a ranging device to the ranging target point.

### Effect

An example advantage according to the present invention is to suitably calculate information on ranging errors.

### BRIEF DESCRIPTION OF THE DRAWINGS

FIG. 1 is a block diagram showing a configuration of a ranging error calculation device in a first example embodiment.

FIG. 2 illustrates an example of a flowchart executed by the ranging error calculation device in the first example embodiment.

FIG. 3 is a diagram showing the overall configuration of the ranging system in a second example embodiment.

FIG. 4 illustrates an example of a hardware configuration of the ranging error calculation device.

FIG. 5 is an example of a block diagram showing a functional configuration of the ranging error calculation device.

FIG. 6 illustrates an example of the data structure of information held by the ranging information holding means.

FIG. 7 illustrates an example of the data structure of information held by the ranging error distribution information holding means.

FIG. 8 illustrates an example of a flowchart showing the operation of the ranging error calculation device relating to the generation of ranging error distribution information in the second example embodiment.

FIG. 9 is an example of a flowchart showing a generation operation of the ranging error information executed by the ranging error calculation device.

FIG. 10 is a diagram showing an overall configuration of a ranging system in a third example embodiment.

FIG. 11 is a functional block diagram of the ranging error calculation device in the third example embodiment.

FIG. 12 shows an example of the data structure of the information held by the ranging error distribution information holding means in the third example embodiment.

FIG. 13 is a block diagram showing a configuration of a ranging error calculation device in a fourth example embodiment.

FIG. 14 is an example of a flowchart showing the operation of the ranging error calculation device relating to the error model generation in the fourth example embodiment along with FIG. 15.

FIG. 15 is an example of a flowchart showing the operation of the ranging error calculation device relating to the error model generation in the fourth example embodiment along with FIG. 14.

### EXAMPLE EMBODIMENTS

Hereinafter, example embodiments of a ranging error calculation device, a ranging error calculation method, and a storage medium will be described with reference to the drawings.

### First Example Embodiment

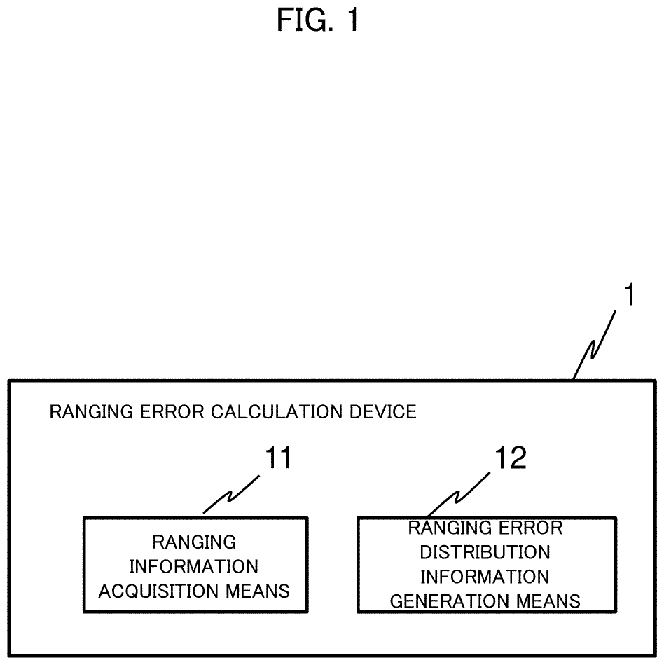

FIG. 1 is a block diagram showing a configuration of a ranging error calculation device 1 in the first example embodiment. The ranging error calculation device 1 includes a ranging information acquisition means 11, and a ranging error distribution information generation means 12. The ranging error calculation device 1 may be configured by a plurality of devices. In this case, the plurality of devices exchange information necessary for the processing assigned to each of them with one another.

The ranging information acquisition means 11 is configured to acquire ranging information in time series with respect to a ranging target point for each of one or more feature information of the ranging target point.

The ranging error distribution information generation means 12 is configured, based on the ranging information, to generate ranging error distribution information, for the each of one or more feature information, regarding an error distribution in measured distance from a ranging device to the ranging target point.

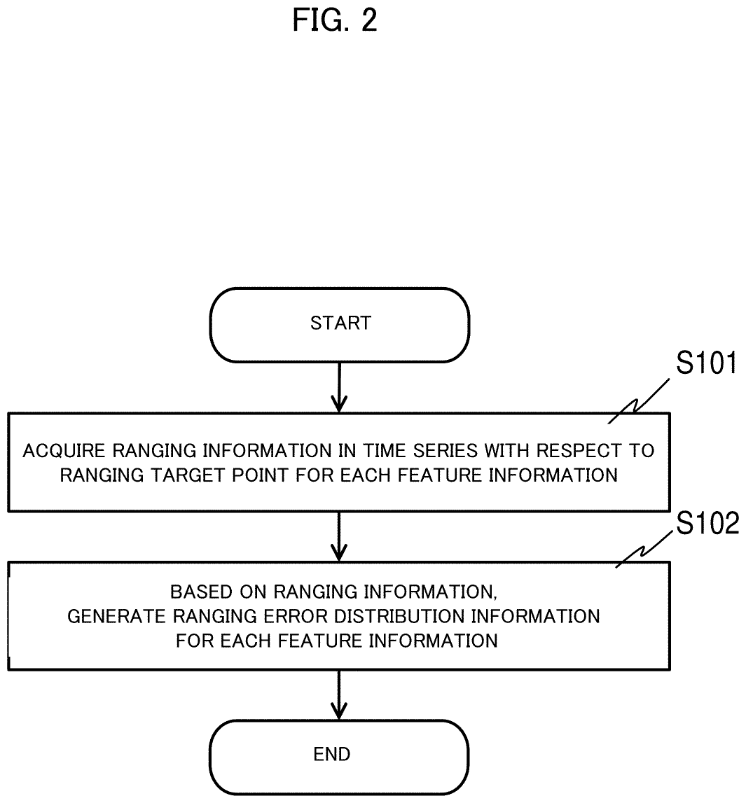

FIG. 2 is an example of a flowchart executed by the ranging error calculation device 1 in the first example embodiment. The ranging information acquisition means 11 of the ranging error calculation device 1 is configured to acquire ranging information in time series with respect to a ranging target point for each of one or more feature information of the ranging target point (step S101). Then, based on the ranging information, the ranging error distribution information generation means 12 of the ranging error calculation device 1 generates ranging error distribution information, for the each of one or more feature information, relating to an error distribution in measured distance from a ranging device to the ranging target point (step S102).

As described above, the ranging error calculation device 1 in the first example embodiment calculates, for each feature information of each ranging target point, the statistical property (nature) of the ranging information based on the ranging information in time series, thereby to generate ranging error distribution information indicating the property of the ranging error. Accordingly, it is possible to acquire the ranging error distribution information corresponding to each feature information of the target ranging point to be reproduced on the simulation thereby to reflect the ranging error in the simulation. Thus, the ranging error calculation device 1 in the first example embodiment can suitably generate information necessary to reflect the observation error in the measured distance in the real environment in the simulation.

### Second Example Embodiment

Next, a description will be given of the configuration and operation of the ranging error calculation device 1a in the second example embodiment. The second example embodiment is an example embodiment that describes a specific example of the operation of the ranging error calculation device 1 in the first example embodiment. The same configuration and operation as the ranging error calculation device 1 in the first example embodiment will be omitted as appropriate.

(1) Overall Configuration

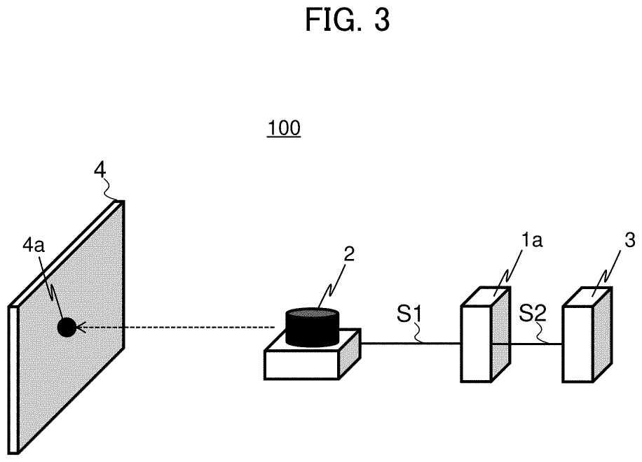

FIG. 3 is a diagram showing the overall configuration of the ranging system 100 in the second example embodiment. The ranging system 100 includes a ranging error calculation device 1a, a ranging device 2, a simulator 3, and a ranging target object 4.

In the second example embodiment, the ranging error calculation device 1a is electrically connected to the ranging device 2 and the simulator 3 by wired or wireless communication.

The ranging device 2 measures, in a predetermined cycle, a distance to each of plural ranging target points including the ranging target point 4a of the ranging target object 4 existing in the vicinity. The ranging device 2 includes, but is not limited to, a device using a laser such as a LiDAR, and a device using a radar. Plural ranging objects 4 may exist. The ranging device 2 supplies the ranging information “S1” indicating the ranging result with respect to the ranging target points to the ranging error calculation device 1a.

The simulator 3 executes a program for reproducing the real world on a virtual environment (desk environment) by a computer. The simulator 3 supplies the ranging error calculation device 1a with feature information (also referred to as “particular feature information”) specified by user input or the like, then receives from the ranging error calculation device 1a ranging error information “S2” indicating the ranging error of the ranging device 2 corresponding to the particular feature information. The particular feature information is, for example, feature information specified by the user operating the simulator 3. Thus, the simulator 3 can reflect the property of the ranging error of the ranging device 2 in the desk environment.

(2) Hardware Configuration of Ranging Error Calculation Device

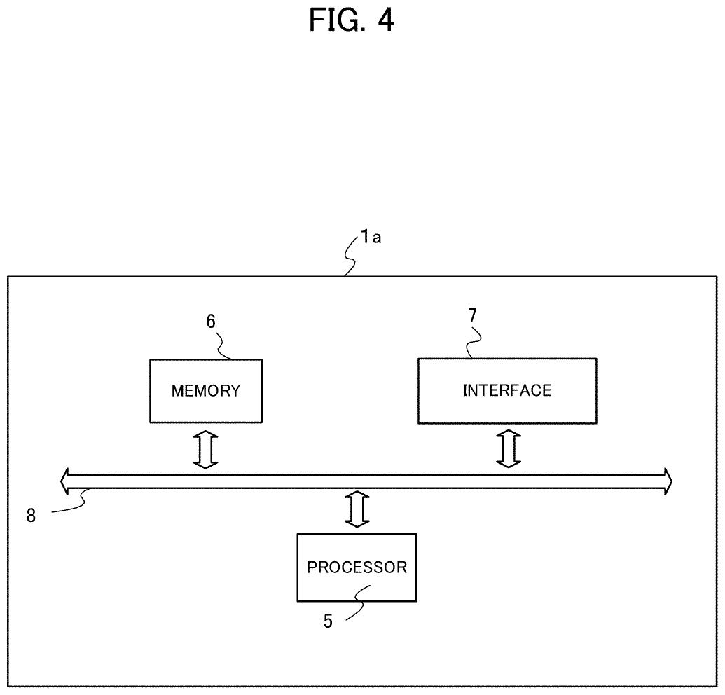

FIG. 4 illustrates an example of the hardware configuration of the ranging error calculation device 1a. The hardware includes a processor 5, a memory 6, and an interface 7. The processor 5, memory 6, and interface 7 are connected to one another via a data bus 8.

The processor 5 functions as a controller configured to control the entire ranging error calculation device 1a by executing a program stored in the memory 6. The processor 5 is one or more processors such as a CPU (Central Processing Unit), GPU (Graphics Processing Unit), and a quantum processor. The processor 5 may configured by a plurality of processors. The processor 5 is an example of a computer.

The memory 6 is configured by various volatile memories such as a RAM (Random Access Memory) and a ROM (Read Only Memory) and a non-volatile memory. In addition, a program for executing a process that is executed by the ranging error calculation device 1a is stored in the memory 6. The program to be executed by the ranging error calculation device 1a may be stored in a storage medium other than the memory 6.

The interface 7 is one or more interfaces for electrically connecting the ranging error calculation device 1a to other devices. For example, the interface 7 includes an interface for connecting the ranging error calculation device 1a to the ranging device 2, and an interface for connecting the ranging error calculation device 1a to the simulator 3. These interfaces may be wireless interfaces, such as network adapters, for transmitting and receiving data to and from other devices wirelessly, or may be a hardware interface, such as a cable, for connecting the ranging error calculation device 1a to other devices.

The hardware configuration of the ranging error calculation device 1a is not limited to the configuration shown in FIG. 4. For example, the ranging error calculation device 1a may include at least one of an input device, a display device, or a sound output device.

(3) Functional Block

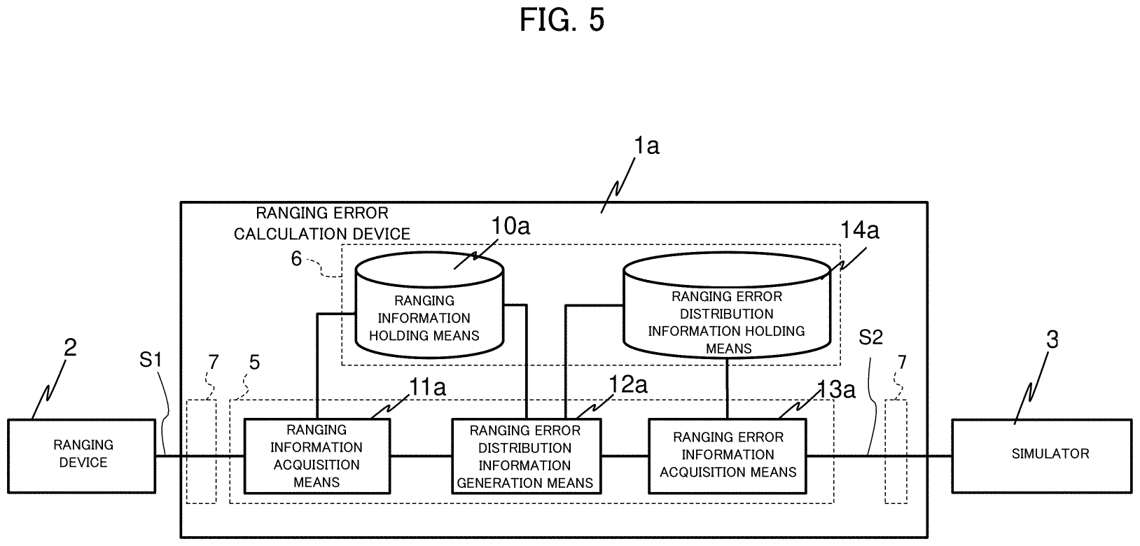

FIG. 5 is an example of a block diagram illustrating a functional configuration of a ranging error calculation device 1a. As shown in FIG. 5, the processor 5 of the ranging error calculation device 1a functionally includes a ranging information acquisition means 11a, a ranging error distribution information generation means 12a, and a ranging error information acquisition means 13a, respectively. The memory 6 includes a ranging information holding means 10a and a ranging error distribution information holding means 14a. In FIG. 5, any two blocks to exchange data or timing signals with each other are connected by solid line, but the combinations of blocks to exchange data or timing signals is not limited to FIG. 5. The same applies to drawings of other functional blocks described below.

The ranging information acquisition means 11a is configured to receive, from the ranging device 2, the ranging information S1 in time series with respect to a ranging target point for each feature information of the ranging target point via the interface 7. The ranging information acquisition means 11a supplies the ranging information holding means 10a with the received ranging information S1 in association with the corresponding feature information of the ranging target point. The ranging information holding means 10a temporarily stores the ranging information S1 in time series with respect to each ranging target point and each feature information thereof. The data structure of the information that the ranging information holding means 10a holds will be described later.

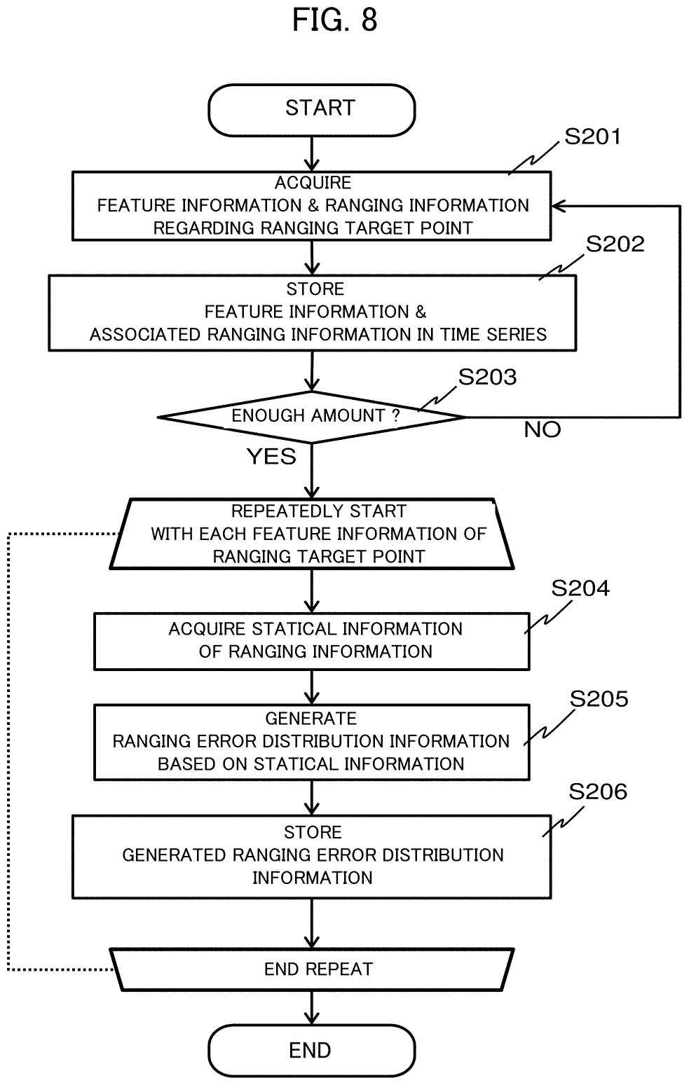

The ranging error distribution information generation means 12a is configured to generate ranging error distribution information for each feature information based on the ranging information held by the ranging information holding means 10a for each feature information of the ranging target point. Here, the ranging error distribution information is information obtained by modeling an error distribution in the measured distance from the ranging device to each ranging target point. A specific method for generating the ranging error distribution information by the ranging error distribution information generation means 12a will be described later with reference to FIG. 8. The ranging error distribution information generation means 12a associates the ranging error distribution information for each feature information of the ranging target point with the each feature information of the ranging target point and supplies it to the ranging error distribution information holding means 14a.

The ranging error information acquisition means 13a is configured to acquire (generate) the ranging error information S2 based on the ranging error distribution information generated by the ranging error distribution information generation means 12a and held by the ranging error distribution information holding means 14a. For example, when the ranging error information acquisition means 13a receives a predetermined request (i.e., external input) indicating the particular feature information from the simulator 3, it calculates the ranging error of the ranging device 2 corresponding to the particular feature information, and supplies the ranging error information S2 indicating the calculated ranging error to the simulator 3 via the interface 7.

The ranging error distribution information holding means 14a is configured to hold the ranging error distribution information generated by the ranging error distribution information generation means 12a in association with the feature information of the ranging target point. At least one of the ranging information holding means 10a and the ranging error distribution information holding means 14a may be realized by one or more devices other than the ranging error calculation device 1a. In this instance, the ranging error calculation device 1a is electrically connected to the above-described devices by wired or wireless communication via the interface 7, and transmits and receives the required information to and from the above-described devices. In this case, the devices may be a cloud server configured by a plurality of devices.

The respective components that are the ranging information acquisition means 11a, ranging error distribution information generation means 12a and ranging error information acquisition means 13a described in FIG. 5 can be realized, for example, by the processor 5 executing a program. The necessary program may be recorded on any non-volatile storage medium and installed as necessary to realize each component. It should be noted that at least a part of these components may be implemented by any combination of hardware, firmware, and software, or the like, without being limited to being implemented by software based on a program. At least some of these components may also be implemented using user programmable integrated circuit such as, for example, FPGA (field-programmable gate array) or microcontrollers. In this case, the integrated circuit may be used to realize a program to realize each of the above components. Further, at least a part of the components may be configured by ASSP (Application Specific Standard Produce) or ASIC (Application Specific Integrated Circuit). Thus, each component may be implemented in hardware other than a processor. The above is true of other example embodiments described later.

(4) Data Structure

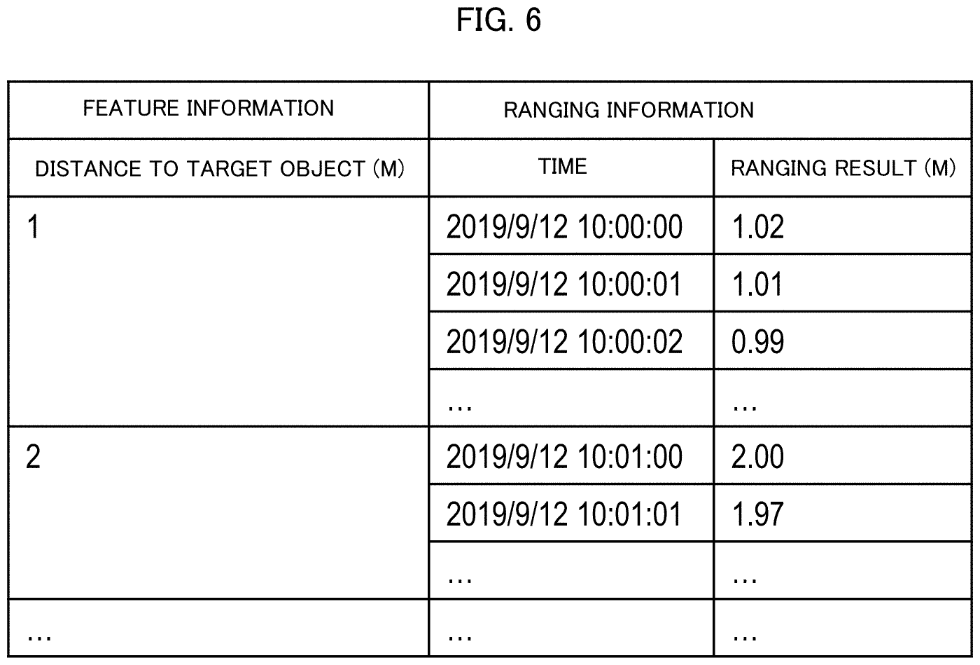

FIG. 6 shows an example of the data structure of the information held by the ranging information holding means 10a. As illustrated in FIG. 6, the ranging information holding means 10a stores each feature information of a ranging target point in association with time-series ranging information S1 for the ranging target point. Here, the ranging information holding means 10a stores the feature information indicating the distance to the already-measured ranging target point, and the ranging information S1 that is time-series combinations of the ranging time and the ranging result with respect to the already-measured ranging target point.

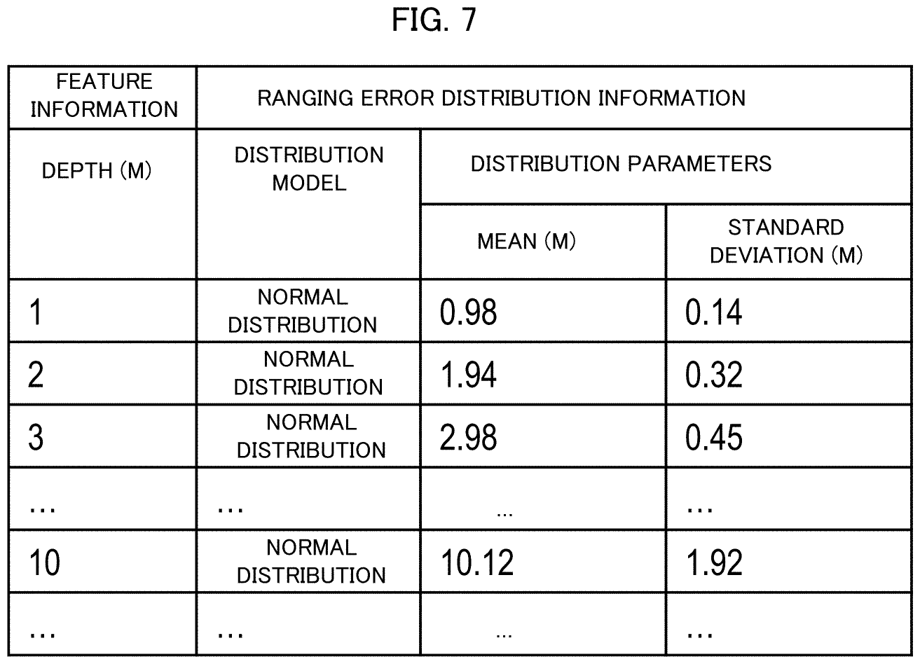

FIG. 7 shows an example of the data structure of the information held by the ranging error distribution information holding means 14a. As shown in FIG. 7, the ranging error distribution information holding means 14a stores the feature information and the ranging error distribution information in association with each other. Here, the ranging error distribution information holding means 14a stores the feature information indicative of the distance (i.e., the depth information) to the already-measured ranging target point. The ranging error distribution information holding means 14a stores the ranging error distribution information indicative of the distribution model and one or more distribution parameters representing the distribution in the ranging error. Here, the distribution model is a normal distribution, and the distribution parameters are the average (here, ranging mean) and standard deviation, which are parameters of the normal distribution. A method of generating the ranging error distribution information will be described with reference to a flowchart in FIG. 8 described below.

(5) Processing Flow

FIG. 8 is an example of a flowchart illustrating the operation relating to the generation of ranging error distribution information by the ranging error calculation device 1a according to the second example embodiment.

The ranging information acquisition means 11a of the ranging error calculation device 1a acquires the feature information and the ranging information S1 regarding a ranging target point (step S201). Then, the ranging information acquisition means 11a temporarily stores the feature information regarding the ranging target point in association with the ranging information S1 acquired in time series in the ranging information holding means 10a (step S202). The ranging information acquisition means 11a may erase the feature information and the ranging information S1 after being used in generating the statistical information at step S204.

Next, the ranging information acquisition means 11a determines whether or not the information amount of the acquired ranging information S1 is enough to calculate the ranging error distribution information for each feature information of the ranging target point (step S203). For example, when the number of samples of the ranging information S1 for each feature information of the ranging target point is equal to or larger than a predetermined threshold value, the ranging information acquisition means 11a determines that the information amount of the acquired ranging information S1 is enough to calculate the ranging error distribution information for each feature information of the ranging target point. The above-described threshold is determined in advance to be, for example, the number of samples required to obtain significant statistical information regarding the ranging information S1, and is stored in advance in the memory 6 or the like.

Then, if the ranging information acquisition means 11a determines that the information amount of the acquired ranging information S1 is not enough to calculate the ranging error distribution information for each feature information of the ranging target point (step S203; No), it proceeds with the processes at step S201 and step S202 again.

If the ranging information acquisition means 11a determines that the information amount of the acquired ranging information S1 is enough to calculate the ranging error distribution information for each feature information of the ranging target point (step S203; Yes), the ranging error distribution information generation means 12a of the ranging error calculation device 1a repeats the processes at step S204 to S206 described below for each feature information of the ranging target point.

At step S204, the ranging error distribution information generation means 12a acquires statistical information of the ranging information S1 corresponding to the target feature information (step S204). Specific examples of the statistical information in the present example embodiment include distribution information of the ranging results for each distance.

Subsequently, the ranging error distribution information generation means 12a generates ranging error distribution information based on the acquired statistical information (step S205). For example, the ranging error distribution information includes information indicating a distribution model and one or more distribution parameters. The ranging error distribution information generation means 12a stores the generated ranging error distribution information in the ranging error distribution information holding means 14a (step S206). The ranging error distribution information generation means 12a executes the processes at S204 to S206 for all the feature information, respectively.

Here, a supplemental description will be given of the distribution model and the distribution parameters included in the ranging error distribution information to be calculated at step S205.

The distribution model is an equation regarding ranging information S1 generated based on statistical information of the ranging information S1, and specific examples of the ranging information S1 include a normal distribution, a uniform distribution, a lognormal distribution, an exponential distribution, and an Erlang distribution. Here, as an example of a generation method of the distribution model in the operation of generating the ranging error distribution information at step S205, the ranging error distribution information generation means 12a prepares a plurality of distribution models in advance, and calculates a degree (i.e., an error) of fitting (matching) between each distribution model and the statistical information. Then, the ranging error distribution generation means 12a selects the optimum distribution model with the least error. In this case, information on the plurality of distribution models is stored in advance in the memory 6 or the like.

The distribution parameters are numerical information for uniquely defining the shape of the distribution model. The number of the distribution parameters and the types thereof differ depending on the distribution model. For example, in a normal distribution, the mean and standard deviation (or variance) are the distribution parameters. As an example of a distribution parameter generation method in the operation of generating the ranging error distribution information at step S205, the ranging error distribution information generation means 12a calculates a degree (i.e., an error) of fitting (matching) between each distribution model and the statistical information while changing the values of the distribution parameters. Then, the ranging error distribution information generation means 12a recognizes the combination of the distribution parameters and the distribution model minimizing the error as the model most approximating the error distribution, and generates ranging error distribution information indicating the combination. The calculation of the distribution parameters to minimize the error may be based on any optimization method or numerical analysis method.

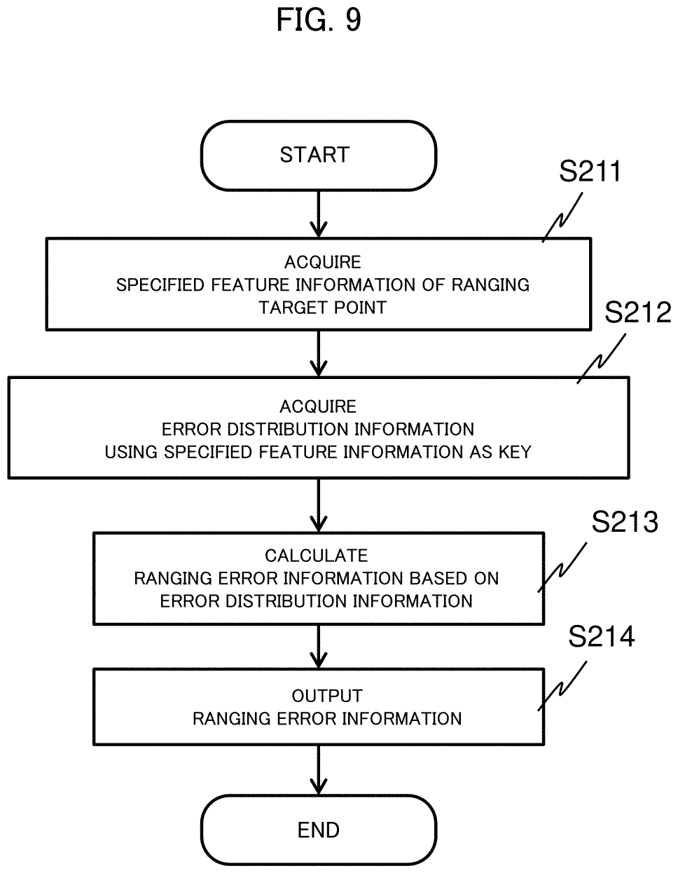

Next, the operation of generating the ranging error information S2 based on the ranging error distribution information will be described with reference to the drawings. FIG. 9 is an example of a flowchart illustrating an operation of generating the ranging error information S2 to be executed by the ranging error calculation device 1a.

First, the ranging error calculation device 1a acquires the specific feature information of the ranging target point from the simulator 3 (step S211). Subsequently, the ranging error information acquisition means 13a of the ranging error calculation device 1a acquires the error distribution information from the ranging error distribution information holding means 14a using the acquired particular feature information as a retrieval key (step S212).

The ranging error information acquisition means 13a calculates the ranging error information S2 based on the error distribution information acquired at step S212 (step S213). For example, the ranging error information acquisition means 13a calculates the ranging error information S2 according to the following procedure. First, the ranging error information acquisition means 13a generates a cumulative distribution function of the ranging error from the distribution model and the distribution parameters included in the error distribution information. Then, the ranging error information acquisition means 13a generates a random number between 0 and 1, and determines the ranging error information S2 that is a value obtained by inputting the random number to the inverse function of the cumulative distribution function as an argument. Accordingly, the ranging error information acquisition means 13a can acquire the ranging error information S2 that is a value in accordance with the distribution of the ranging error.

After that, the ranging error information acquisition means 13a outputs the calculated ranging error information S2 to the simulator 3 (step S214), and ends the operation.

(6) Effect

Next, a description will be given of the effect according to the second example embodiment. The ranging error calculation device 1a in the second example embodiment can simulate observation errors which occurs in a real world environment. In other words, the ranging error calculation device 1a calculates, for each feature information of each ranging target point, the statistical property of the ranging information based on the ranging information in time series thereby to generate, based on the statistical property, the ranging error distribution information indicating the feature of the ranging error. Further, the ranging error calculation device 1a acquires the ranging error distribution information corresponding to the particular feature information based on the request (i.e., external input) from the simulator 3, and thereby calculates the ranging error information S2 based on the acquired information and output the ranging error information S2 to the simulator 3. Therefore, the ranging error calculation device 1a according to the second example embodiment can simulate a ranging error closer to the real ranging error in the real environment based on the statistical property of the ranging data S1 indicating the ranging result of the ranging device 2.

### Third Example Embodiment

Next, a description will be given of the configuration and operation of the ranging error calculation device 1b in the third example embodiment. In the third example embodiment, a three-dimensional imaging device is used as the ranging device 2 in the second example embodiment. It is noted that the same components and processes as the ranging error calculation device 1 in the first example embodiment or the ranging error calculation device 1a in the second example embodiment are appropriately denoted by the same reference numerals, and a description thereof will be omitted.

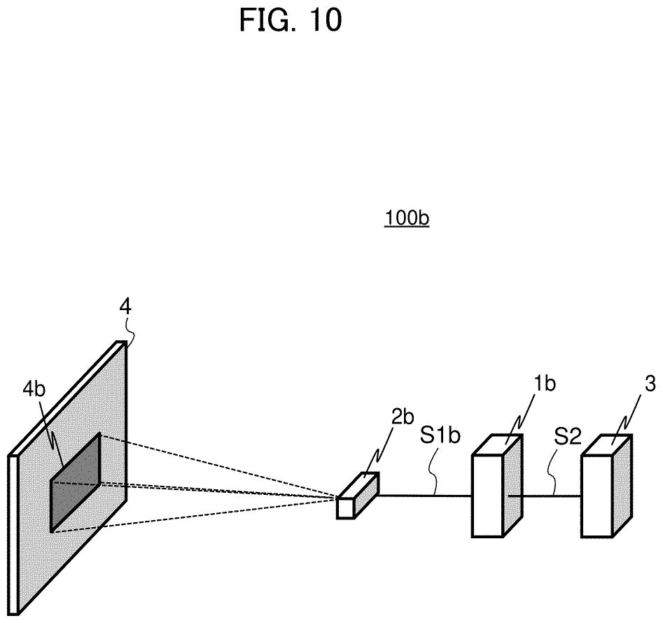

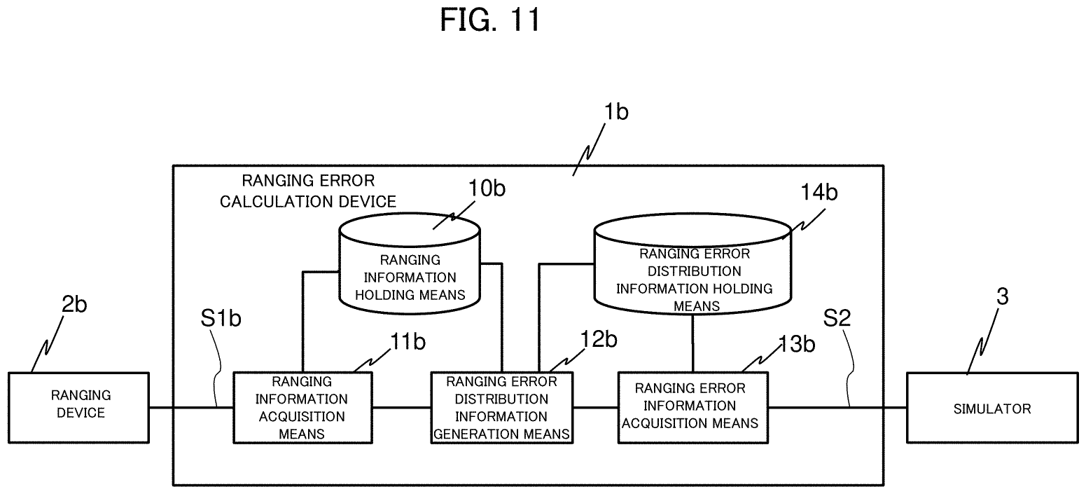

FIG. 10 is a diagram illustrating the entire configuration of the ranging system 100b in the third example embodiment. Further, FIG. 11 shows a functional block diagram of the ranging error calculation device 1b in the third example embodiment. In the third example embodiment, the ranging device 2b is a three-dimensional imaging device, and the ranging error calculation device 1b performs a process according to the property of the ranging device 2b. For example, the ranging error calculation device 1b has a hardware configuration shown in FIG. 4 in the same way as the ranging error calculation device 1a in the second example embodiment.

The ranging device 2b is a three-dimensional imaging device, and measures the distance to an object around the installation position. Specific examples of the three-dimensional imaging device include a stereo camera and a TOF camera using a TOF (Time of Flight) method. The ranging device 2b supplies the three-dimensional imaging data “S1b” of the ranging target surface 4b of the ranging object 4 included in the imaging range to the ranging error calculation device 1b.

Three-dimensional imaging device is configured to acquire the depth information by using one or more imaging devices such as a camera. Therefore, it is possible to acquire a wide range of ranging information in the imaging range at a time. On the other hand, due to the optical property of the imaging device, the variation in the ranging errors within the imaging range is likely to occur. For example, when the central portion and the peripheral portion in the imaging range are compared, the ranging error of the peripheral portion generally becomes larger. This is due to the worse conditions of incidence of light and laser onto the sensor in the peripheral portion than in the central portion.

The ranging information acquisition means 11b receives the three-dimensional imaging information S1b from the ranging device 2b, and stores information based on the three-dimensional imaging information S1b in the ranging information holding means 10b. In this instance, the ranging information acquisition means 11b acquires, as the feature information of the ranging target point, not only information indicating the distance to the already-measured ranging target point but also plane coordinate information of the respective ranging target points included in the ranging target plane 4b. The plane coordinate information is coordinate information in the imaging range of the ranging device 2b. Then, the ranging information acquisition means 11b recognizes the ranging information corresponding to the acquired feature information (i.e., information on the distance to the respective ranging target points) based on the three-dimensional imaging information S1b, and stores each feature information in the ranging information holding means 10b in association with the corresponding ranging information.

The ranging error distribution information generation means 12b acquires the feature information of each ranging target point included in the ranging target plane 4b, wherein the feature information includes not only information indicating the distance to the already-measured ranging target point but also the plane coordinate information of each ranging target point included in the ranging target plane 4b. The ranging error distribution information generation means 12b generates ranging error distribution information for each acquired feature information. Then, the ranging error distribution information generation means 12b stores the ranging error distribution information for each feature information in the ranging error distribution information holding means 14b. Therefore, the ranging error distribution information holding means 14b stores the feature information of each ranging target point that includes not only the distance to the already-measured ranging target point but also the plane coordinate information in the imaging range of the ranging target points.

The ranging error information acquisition means 13b acquires the feature information from the simulator 3 and calculates the ranging errors based on the acquired feature information, wherein the acquired feature information includes not only the information indicating the distance to the already-measured ranging target point but also the plane coordinate information in the imaging range of the ranging target points. The ranging error information acquisition means 13b supplies the ranging error information S2 indicating the calculated ranging errors to the simulator 3.

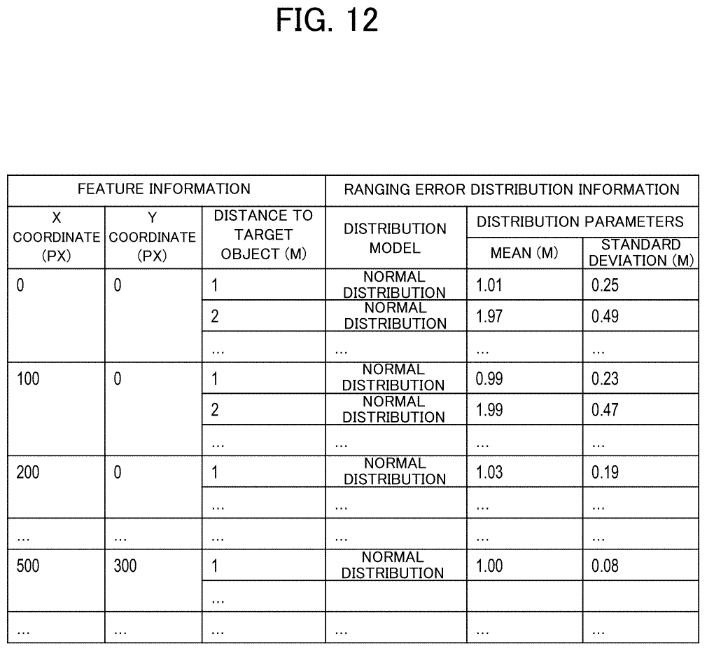

FIG. 12 shows an example of the data structure of the information held by the ranging error distribution information holding means 14b according to the third example embodiment. The ranging error distribution information holding means 14b stores the feature information of the ranging target points in association with the ranging error distribution information, wherein the feature information includes not only the information indicating the distance to the already-measured ranging target point but also sets of the X coordinate value and the Y coordinate value which are plane coordinates in the imaging range. The ranging error distribution information holding means 14b stores ranging error distribution information calculated by the ranging error distribution information generation means 12b for each combination of the distance to the ranging target point, the X coordinate value, and the Y coordinate value.

Next, a description will be given of the effect according to the third example embodiment. The ranging error calculation device 1b in the third example embodiment can simulate the observation error closer to the real observation error in the real environment by adopting the above-described configuration and operation. Namely, the ranging error calculation device 1b uses the plane coordinate information in the imaging range of the ranging target points in addition to the distance to the ranging target point as the feature information for each ranging target point. Accordingly, the ranging error calculation device 1b can calculate the statistical property of the ranging information in consideration of the influence on the ranging error from the position in the imaging range of the ranging target point, and thereby generate the ranging error distribution information based on the calculation result. Therefore, the ranging 100b can reproduce a ranging error closer to the real ranging error in the real environment based on the optical property of the ranging device in addition to the statistical property of the ranging information of the ranging device.

### Fourth Example Embodiment

Next, a description will be given of the configuration and operation of the ranging error calculation device 1c in the fourth example embodiment. The description regarding the same components and processes as those of the ranging error calculation device 1 and 1a, 1b in the first example embodiment to the third example embodiment will be omitted as appropriate.

In the fourth example embodiment, the ranging error calculation device operates to generate the ranging error distribution information even when the information amount of the ranging information for generating the ranging error distribution information is insufficient in the second example embodiment. In the present example embodiment, an exemplary application to the ranging error calculation device 1a in the second example embodiment will be described, but the present example embodiment is also applicable to the ranging error calculation device 1b in the third example embodiment in the same manner.

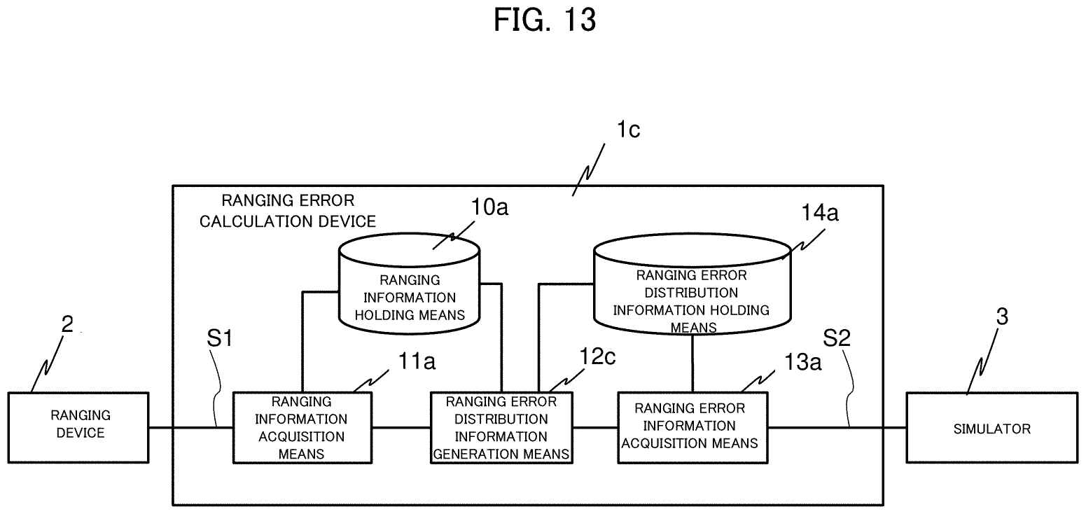

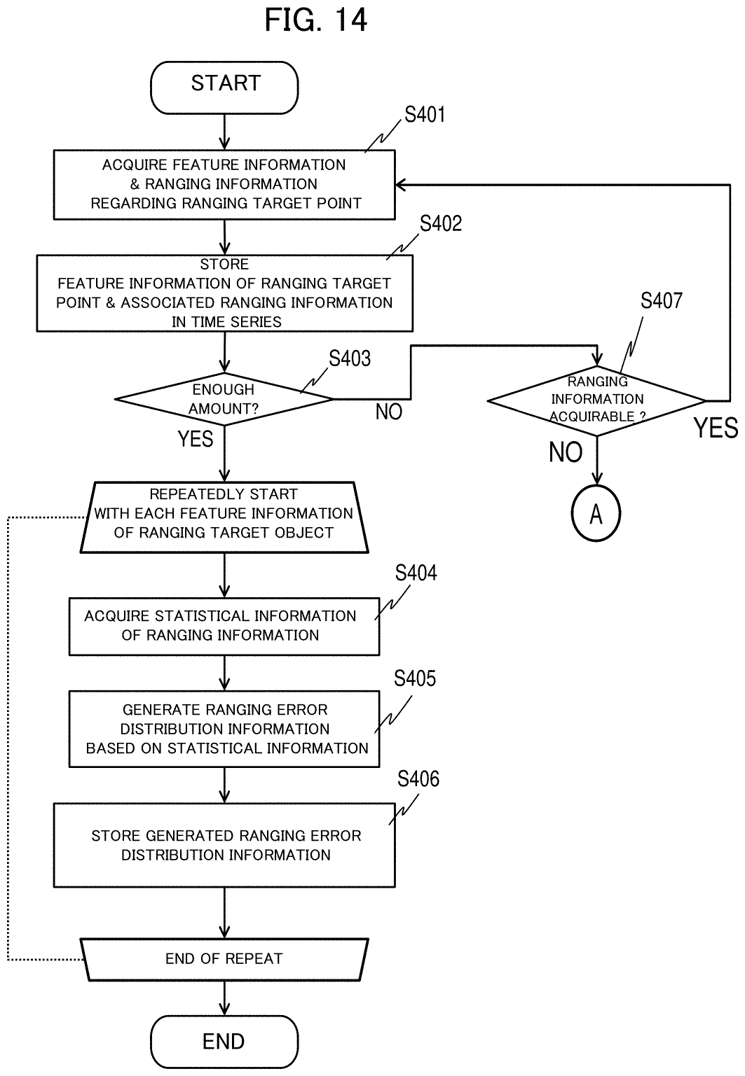

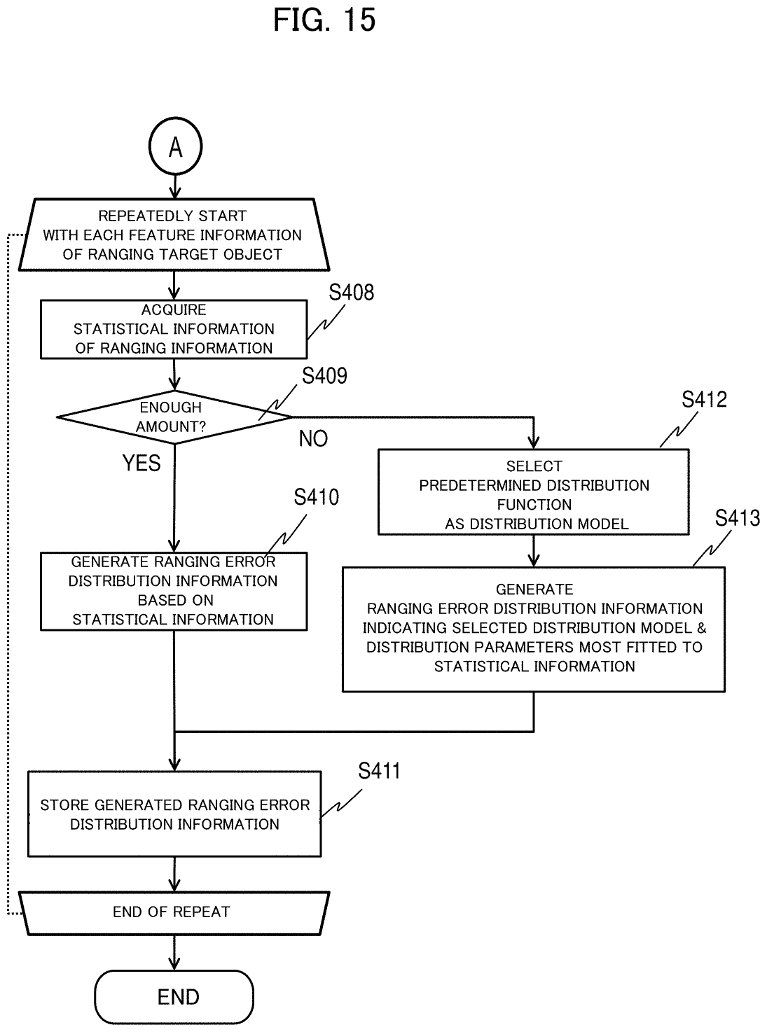

FIG. 13 is a block diagram showing a configuration of a ranging error calculation device 1c according to the fourth example embodiment. The difference between the ranging error calculation device 1a in the second example embodiment and the ranging error calculation device 1c in the fourth example embodiment is the operation of the ranging error distribution information generation means 12c of the ranging error calculation device 1c. Detailed operation of the ranging error distribution information generation means 12c will be described in detail with reference to the flowcharts shown in FIGS. 14 and 15.

FIGS. 14 and 15 are examples of flowcharts illustrating operations related to error model generation by the ranging error calculation device 1c according to the fourth example embodiment. Hereafter, the operation of the ranging error distribution information generation means 12c will be described focusing on the difference from the operation in the second example embodiment.

The ranging error calculation device 1c performs the same processes at step S401 and step S402 as the processes at step S201 and step S202 in FIG. 8, respectively. Then, the ranging error calculation device 1c determines whether or not the information amount of the acquired ranging information S1 is enough to calculate the ranging error distribution information for each feature information of the ranging target point (step S403). The criterion at step S403 is identical to that at step S203. When the information amount of the acquired ranging information S1 is enough to calculate the ranging error distribution information for each feature information of the ranging target point (step S403; Yes), the ranging error calculation device 1c executes the processes at step S404 to step S406 for each feature information of the ranging target point. The processes at step S404 to step S406 are identical to the processes at step S204 to step S206 in FIG. 8, respectively.

On the other hand, when the information amount of the acquired ranging information S1 is not enough to calculate the ranging error distribution information for each feature information of the ranging target point (step S403; No), the ranging error calculation device 1c determines whether or not it is possible to acquire additional ranging information S1 (step S407). When the additional ranging information S1 can be acquired (step S407; Yes), the ranging error calculation device 1c acquires and stores the additional ranging information S1 by getting back to the process at step S401. On the other hand, when the additional ranging information S1 cannot be acquired (step S407; NO), the ranging error distribution information generation means 12c of the ranging error calculation device 1c executes the process A shown in FIG. 15.

In the process A, the ranging error distribution information generation means 12c repeatedly performs a process relating to step S408 to step S413 described below for each feature information of the ranging target points (i.e., for each feature information of all target ranging target points).

First, the ranging error distribution information generation means 12c acquires statistical information of the ranging information S1 (step S408). In this case, the ranging error distribution information generation means 12c acquires the statistical information of the ranging information S1 by performing the same process as the process at step S204 in FIG. 8.

Next, the ranging error distribution information generation means 12c determines whether or not the information amount of the acquired statistical information is enough (adequate) for the generation of the ranging error distribution information (step S409). Since the bias may occur in the information amount acquired for each feature information, the ranging error distribution information generation means 12c determines, at step S409, whether or not the information amount of the statistical information regarding the target feature information is enough for generating the ranging error distribution information. For example, the ranging error distribution information generation means 12c determines that the above-described information amount is enough when the number of samples used for calculating the statistical information of the target feature information is equal to or more than a predetermined threshold value while determining that the above-described information amount is not enough when the number of samples used for calculating the statistical information of the target feature information is smaller than the threshold value.

Then, the ranging error distribution information generation means 12c determines that the information amount of the statistical information regarding the target feature information is enough for generating the ranging error distribution information (step S409; Yes), the ranging error distribution information generation means 12c generates the ranging error distribution information in the same way as the processes at step S205 in FIG. 8 in the second example embodiment (step S410). The ranging error distribution information generation means 12c stores the generated ranging error distribution information in the ranging error distribution information holding means 14a (step S411).

On the other hand, if the ranging error distribution information generation means 12c determines that the information amount of the statistical information regarding the target feature information is not enough for generating the ranging error distribution information (step S409; No), the ranging error distribution information generation means 12c selects a predetermined distribution function as the distribution model (step S412). Specific examples of the predetermined distribution function include a normal distribution and a lognormal distribution. Next, the ranging error distribution information generation means 12c generates ranging error distribution information indicating the selected distribution model and the distribution parameters having the highest fitting (matching) between the selected distribution model and the statistical information (step S413). In this case, the ranging error distribution information generation means 12c uses the distribution model selected at step S412 as the distribution model subject to fitting (matching), and determines the values of the distribution parameters having the smallest error among plural sets of the values of the distribution parameters. Then, the ranging error distribution information generation means 12c generates ranging error distribution information indicating the distribution model selected at step S412 and the determined distribution parameters. Thereafter, the ranging error distribution information generation means 12c stores the generated ranging error distribution information in the ranging error distribution information holding means 14a (step S411). The ranging error distribution information generation means 12c ends the flowchart when the processes at step S408 to step S411 is completed for all feature information of all ranging target points.

Next, a description will be given of the effect according to the fourth example embodiment. By adopting such a configuration and an operation, the ranging error calculation device 1c in the fourth example embodiment can acquire more suitable ranging error distribution information even in a situation that the ranging information S1 cannot be sufficiently acquired. Under such a condition that the information amount of the ranging information S1 is insufficient, it is difficult to grasp the statistical properties of the ranging information S1, and therefore a distribution modeling far from the actual error distribution could be selected. Taking the above into consideration, the ranging error calculation device 1c according to the fourth example embodiment avoids the inappropriate distribution model from being selected by using the distribution function as prior information. Thereby, even when the information amount of the ranging information S1 is insufficient, it is possible to generate better ranging error distribution information, and thereby to reflect the ranging error closer to actual error in the actual environment in the simulation.

[Modifications]

Although the example embodiments of the present invention have been described in detail with reference to the drawings, the specific configuration is not limited to those described above, and various design changes and the like can be made unless the gist of the present invention is changed. Here, a description will be given of preferred modifications to the first example embodiment to the fourth example embodiment. The following modifications may be applied to the above example embodiments in any combination.

(First Modification)

The functions of the ranging error calculation device may be configured and performed by a plurality of devices connected via a data exchangeable communication medium such as a network. In other words, the ranging error calculation device according to any one of the first example embodiment to the fourth example embodiment may be configured by a plurality of devices electrically connected to one another.

(Second Modification)

Examples of the feature information of the ranging target point may further include color information of the ranging target point. In this instance, the ranging error calculation device calculates the ranging error distribution information for each class (category) of colors based on the ranging information S1 for each class (category) of colors indicated by the color information.

The ranging error calculation device according to such a configuration and operation can generate the ranging error distribution information in consideration of the reflection property of the laser or radar affected by the difference in the color of the ranging target point at the time of ranging. Therefore, the ranging error calculation device can reflect the ranging error closer to the actual ranging error in the real environment in the simulation.

(Third Modification)

Examples of the feature information of the ranging target point may further include an incident angle from the ranging device to the ranging target point. In this instance, the ranging error calculation device calculates the ranging error distribution information for each incident angle based on the ranging information S1 for each incident angle (which may be each incident angle range with a predetermined length).

The ranging error calculation device according to such a configuration and operation can generate ranging error distribution information considering the reflection property of the laser or radar affected by the difference in the incident angle to the ranging target point at the time of ranging. Therefore, the ranging error calculation device can reflect the ranging error closer to the actual ranging error in the real environment in the simulation.

(Fourth Modification)

If the feature information that matches the particular feature information acquired from the simulator 3 is not stored in the ranging error distribution information holding means 14a, the ranging error information acquisition means 13a or 13b may generate the ranging error information S2 based on the ranging error distribution information corresponding to other plural feature information.

In this instance, the ranging error information acquisition means 13a or 13b acquires a set of: feature information held by the ranging error distribution information holding means 14a that is similar to the particular feature information acquired from the simulator 3; and the ranging error distribution information associated with the above-mentioned feature information. Examples of the feature information that is similar to the particular feature information is one or more feature information whose distance with respect to the depth (and plane coordinates) from the particular feature information is equal to or smaller than a predetermined distance, and a predetermined number of feature information having shortest distances with respect to the depth (and plane coordinates) from the particular feature information. When the ranging error distribution information is acquired from the ranging error distribution information holding means 14a, the ranging error information acquisition means 13a or 13b acquires the ranging error distribution information whose distribution model is in common.

Then, furthermore, the ranging error information acquisition means 13a or 13b weights each of the acquired ranging error distribution information according to the distance between each acquired feature information and the particular feature information acquired from the simulator 3. In this instance, the ranging error information acquisition means 13a or 13b performs weighted averaging of the distributed parameters according to the difference in depth (and plane coordinates) between each acquired feature information and the particular feature information acquired from the simulator 3. In this instance, the ranging error information acquisition means 13a or 13b sets the respective weights so as to increase the weight for the distribution parameters regarding the each acquired feature information with the decrease in the above-mentioned difference regarding the each acquired feature information. Then, the ranging error information acquisition means 13a or 13b generates ranging error information S2 based on the weighted average ranging error distribution information.

The ranging error calculation device according to such a configuration and operation can calculate the ranging error using the ranging error distribution information of the approximate feature information even when the feature information of the ranging target point is not comprehensively prepared. Accordingly, even based on the error model generation operation in a simpler or time-saving way, it is possible to reflect in the simulation the ranging error closer to the actual error in the actual environment.

Further, a program for realizing all or a part of functions of the ranging error calculation device according to the present disclosure may be recorded in a storage medium that can be read by a computer, and a computer system may read the program recorded in the storage medium to execute the processing to be executed by each part. Examples of the “computer system” as used herein shall include hardware such as OS and peripheral equipment.

Examples of the “storage medium storing a program to be executed by a computer” include an optical disk, a ROM, a portable medium such as a non-volatile solid-state memory, and a storage device such as a hard disk embedded in the computer system. Further, examples of the “storage medium storing a program to be executed by a computer” also include what dynamically holds the program for a short period of time such as network like the Internet and a communication line to be used for transmitting a program and what holds the program for a certain period of time such as a volatile memory in the computer system serving as a server or a client. The above-described program may be for realizing a part of the above-described functions, or may be a program for realizing the functions with the combination of programs already recorded in the computer system.

The whole or a part of the example embodiments described above can be described as, but not limited to, the following Supplementary Notes.

[Supplementary Note 1]

A ranging error calculation device comprising:

a ranging information acquisition means configured to acquire ranging information in time series with respect to a ranging target point for each of one or more feature information of the ranging target point; and

a ranging error distribution information generation means configured, based on the ranging information, to generate ranging error distribution information, for the each of one or more feature information, regarding an error distribution in measured distance from a ranging device to the ranging target point.

[Supplementary Note 2]

The ranging error calculation device according to Supplementary Note 1,

wherein the ranging error distribution information generation means is configured to
calculate statistical information of the ranging information for the each of one or more feature information and
generate the ranging error distribution information based on the statistical information.

[Supplementary Note 3]

The ranging error calculation device according to Supplementary Note 1 or 2,

wherein the ranging error distribution information generation means is configured to generate the ranging error distribution information that is information indicative of
the distribution model of the error distribution and
a distribution parameter that is a parameter of the distribution model.

[Supplementary Note 4]

The ranging error calculation device according to Supplementary Note 3,

wherein the ranging error distribution information generation means is configured to
use, as the distribution model, a distribution function whose error from statistical information of the ranging information is the smallest among specified plural distribution functions, and
determine the distribution parameter to be a parameter of the distribution function when the error from the statistical information is the smallest.

[Supplementary Note 5]

The ranging error calculation device according to Supplementary Note 3,

wherein the ranging error distribution information generation means is configured to use, as the distribution model, a predetermined distribution function if information amount of the ranging information is less than a predetermined threshold value.

[Supplementary Note 6]

The ranging error calculation device according to any one of Supplementary Notes 1 to 5,

wherein the one or more feature information includes information on a distance from the ranging device to the ranging target point.

[Supplementary Note 7]

The ranging error calculation device according to any one of Supplementary Notes 1 to 6,

wherein the ranging information is three-dimensional imaging information, and

wherein the one or more feature information includes plane coordinate information of the ranging target point in the three-dimensional imaging information.

[Supplementary Note 8]

The ranging error calculation device according to any one of Supplementary Notes 1 to 7,

wherein the one or more feature information includes color information of the ranging target point.

[Supplementary Note 9]

The ranging error calculation device according to any one of Supplementary Notes 1 to 8,

wherein the one or more feature information includes an incident angle from the ranging device to the ranging target point.

[Supplementary Note 10]

The ranging error calculation device according to any one of Supplementary Notes 1 to 9, further comprising

a ranging error information acquisition means configured, when receiving an external input specifying particular feature information corresponding to the ranging target point, to
acquire the ranging error distribution information associated with the particular feature information from a ranging error distribution information holding means configured to store the feature information in association with the ranging error distribution information, and
acquire ranging error information indicative of a ranging error corresponding to the particular feature information based on the ranging error distribution information.

[Supplementary Note 11]

The ranging error calculation device according to Supplementary Note 10,

wherein the ranging error information acquisition means is configured, if the feature information which matches the particular feature information is not stored by the ranging error distribution information holding means,
to acquire the ranging error information based on the ranging error distribution information associated with one or more feature information which approximates the particular feature information and which is selected from plural feature information stored by the ranging error distribution information holding means.

[Supplementary Note 12]

The ranging error calculation device according to Supplementary Note 11,

wherein the ranging error information acquisition means is configured to
weight the ranging error distribution information associated with the approximating feature information according to a distance between the approximate feature information and the particular feature information, and
acquire the ranging error information based on the weighted ranging error distribution information.

[Supplementary Note 13]

A ranging error calculation method executed by a computer, the ranging error calculation method comprising:

acquiring ranging information in time series with respect to a ranging target point for each of one or more feature information of the ranging target point; and

based on the ranging information, generating ranging error distribution information, for the each of one or more feature information, regarding an error distribution in measured distance from a ranging device to the ranging target point.

[Supplementary Note 14]

A storage medium storing a program executed by a computer, the program causing the computer to:

acquire ranging information in time series with respect to a ranging target point for each of one or more feature information of the ranging target point; and

based on the ranging information, generate ranging error distribution information, for the each of one or more feature information, regarding an error distribution in measured distance from a ranging device to the ranging target point.

[Supplementary Note 15]

A ranging error calculation system comprising:

a ranging information acquisition means configured to acquire ranging information in time series with respect to a ranging target point for each of one or more feature information of the ranging target point; and

a ranging error distribution information generation means configured, based on the ranging information, to generate ranging error distribution information, for the each of one or more feature information, regarding an error distribution in measured distance from a ranging device to the ranging target point.

[Supplementary Note 16]

The ranging error calculation system according to Supplementary Note 15,

wherein the ranging error distribution information generation means is configured to
calculate statistical information of the ranging information for the each of one or more feature information and
generate the ranging error distribution information based on the statistical information.

[Supplementary Note 17]

The ranging error calculation system according to Supplementary Note 15 or 16,

wherein the ranging error distribution information generation means is configured to generate the ranging error distribution information that is information indicative of
the distribution model of the error distribution and
a distribution parameter that is a parameter of the distribution model.

[Supplementary Note 18]

The ranging error calculation system according to Supplementary Note 17,

wherein the ranging error distribution information generation means is configured to
use, as the distribution model, a distribution function whose error from statistical information of the ranging information is the smallest among specified plural distribution functions, and
determine the distribution parameter to be a parameter of the distribution function when the error from the statistical information is the smallest.

[Supplementary Note 19]

The ranging error calculation system according to Supplementary Note 17,

wherein the ranging error distribution information generation means is configured to use, as the distribution model, a predetermined distribution function if information amount of the ranging information is less than a predetermined threshold value.

[Supplementary Note 20]

The ranging error calculation system according to any one of Supplementary Notes 15 to 19,

wherein the one or more feature information includes information on a distance from the ranging device to the ranging target point.

[Supplementary Note 21]

The ranging error calculation system according to any one of Supplementary Notes 15 to 20,

wherein the ranging information is three-dimensional imaging information, and

wherein the one or more feature information includes plane coordinate information of the ranging target point in the three-dimensional imaging information.

[Supplementary Note 22]

The ranging error calculation system according to any one of Supplementary Notes 15 to 21,

wherein the one or more feature information includes color information of the ranging target point.

[Supplementary Note 23]

The ranging error calculation system according to any one of Supplementary Notes 15 to 22,

wherein the one or more feature information includes an incident angle from the ranging device to the ranging target point.

[Supplementary Note 24]

The ranging error calculation system according to any one of Supplementary Notes 15 to 23, further comprising

a ranging error information acquisition means configured, when receiving an external input specifying particular feature information corresponding to the ranging target point, to
acquire the ranging error distribution information associated with the particular feature information from a ranging error distribution information holding means configured to store the feature information in association with the ranging error distribution information, and
acquire ranging error information indicative of a ranging error corresponding to the particular feature information based on the ranging error distribution information.

[Supplementary Note 25]

The ranging error calculation system according to Supplementary Note 24,

wherein the ranging error information acquisition means is configured, if the feature information which matches the particular feature information is not stored by the ranging error distribution information holding means,
to acquire the ranging error information based on the ranging error distribution information associated with one or more feature information which approximates the particular feature information and which is selected from plural feature information stored by the ranging error distribution information holding means.

[Supplementary Note 26]

The ranging error calculation system according to Supplementary Note 25,

wherein the ranging error information acquisition means is configured to
weight the ranging error distribution information associated with the approximating feature information according to a distance between the approximate feature information and the particular feature information, and
acquire the ranging error information based on the weighted ranging error distribution information.

[Supplementary Note 27]

A ranging error calculation method executed by a ranging error calculation system, the ranging error calculation method comprising:

acquiring ranging information in time series with respect to a ranging target point for each of one or more feature information of the ranging target point; and

based on the ranging information, generating ranging error distribution information, for the each of one or more feature information, regarding an error distribution in measured distance from a ranging device to the ranging target point.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1a to 1c Ranging error calculation device
2, 2b Ranging device
3 Simulator
10a, 10b Ranging information holding means
11, 11a, 11b Ranging information acquisition means
12, 12a to 12c Ranging error distribution information generation means
13a, 13b Ranging error data acquisition means
14a, 14b Ranging error distribution information holding means

What is claimed is:

1. A ranging error calculation device comprising:
at least one memory configured to store instructions; and
at least one processor configured to execute the instructions to:
acquire ranging information in time series with respect to a ranging target point for each of one or more feature information of the ranging target point; and
based on the ranging information, generate ranging error distribution information, for the each of one or more feature information, regarding an error distribution in measured distance from a ranging device to the ranging target point.

2. The ranging error calculation device according to claim 1,
wherein the at least one processor is configured to execute the instructions to
calculate statistical information of the ranging information for the each of one or more feature information and
generate the ranging error distribution information based on the statistical information.

3. The ranging error calculation device according to claim 1,
wherein the at least one processor is configured to execute the instructions to generate the ranging error distribution information that is information indicative of
the distribution model of the error distribution and
a distribution parameter that is a parameter of the distribution model.

4. The ranging error calculation device according to claim 3,
wherein the at least one processor is configured to execute the instructions to
use, as the distribution model, a distribution function whose error from statistical information of the ranging information is the smallest among specified plural distribution functions, and
determine the distribution parameter to be a parameter of the distribution function when the error from the statistical information is the smallest.

5. The ranging error calculation device according to claim 3,
wherein the at least one processor is configured to execute the instructions to use, as the distribution model, a predetermined distribution function if information amount of the ranging information is less than a predetermined threshold value.

6. The ranging error calculation device according to claim 1,
wherein the one or more feature information includes information on a distance from the ranging device to the ranging target point.

7. The ranging error calculation device according to claim 1,
wherein the ranging information is three-dimensional imaging information, and
wherein the one or more feature information includes plane coordinate information of the ranging target point in the three-dimensional imaging information.

8. The ranging error calculation device according to claim 1,
wherein the one or more feature information includes color information of the ranging target point.

9. The ranging error calculation device according to claim 1,
wherein the one or more feature information includes an incident angle from the ranging device to the ranging target point.

10. The ranging error calculation device according to claim 1,
wherein the at least one processor is configured to further execute the instructions, when receiving an external input specifying particular feature information corresponding to the ranging target point, to
acquire the ranging error distribution information associated with the particular feature information from stored feature information in association with the ranging error distribution information, and
acquire ranging error information indicative of a ranging error corresponding to the particular feature information based on the ranging error distribution information.

11. The ranging error calculation device according to claim 10,
wherein the at least one processor is configured to execute the instructions, if the feature information which matches the particular feature information is not stored,
to acquire the ranging error information based on the ranging error distribution information associated with one or more feature information which approximates the particular feature information and which is selected from plural feature information stored.

12. The ranging error calculation device according to claim 11,
wherein the at least one processor is configured to execute the instructions to
weight the ranging error distribution information associated with the one or more feature information which approximates the particular feature information according to a distance between the one or more feature information which approximates the particular feature information and the particular feature information, and
acquire the ranging error information based on the weighted ranging error distribution information.

13. A ranging error calculation method executed by a computer, the ranging error calculation method comprising:
acquiring ranging information in time series with respect to a ranging target point for each of one or more feature information of the ranging target point; and
based on the ranging information, generating ranging error distribution information, for the each of one or more feature information, regarding an error distribution in measured distance from a ranging device to the ranging target point.

14. A non-transitory computer readable storage medium storing a program executed by a computer, the program causing the computer to:
acquire ranging information in time series with respect to a ranging target point for each of one or more feature information of the ranging target point; and
based on the ranging information, generate ranging error distribution information, for the each of one or more feature information, regarding an error distribution in measured distance from a ranging device to the ranging target point.
